(19) United States
(12) Patent Application Publication
(10) Pub. No.: US 2013/0332159 A1
(43) Pub. Date: Dec. 12, 2013

(54) USING FAN THROTTLING TO ENHANCE DICTATION ACCURACY

(71) Applicant: APPLE INC., Cupertino, CA (US)

(72) Inventors: Craig M. Federighi, Los Altos Hills, CA (US); John D. Field, Los Gatos, CA (US); Gary P. Geaves, Los Gatos, CA (US); Ronald N. Isaac, San Ramon, CA (US); Aram M. Lindahl, Menlo Park, CA (US); Eric T. Seymour, San Jose, CA (US); Kim E. Silverman, Mountain View, CA (US); Jeffrey D. Whitman, Campbell, CA (US)

(73) Assignee: Apple Inc., Cupertino, CA (US)

(21) Appl. No.: 13/737,666

(22) Filed: Jan. 9, 2013

Related U.S. Application Data
(60) Provisional application No. 61/657,730, filed on Jun. 8, 2012.

(51) Int. Cl. G10L 15/26

(52) U.S. Cl. CPC G10L 15/26
USPC 704/235; 700/275

(57) ABSTRACT

A dictation computer that includes a fan speed regulator is described. The fan speed regulator monitors a speech recognition unit to determine when the speech recognition unit is activated. Upon detection that the speech recognition unit is activated, the fan speed regulator ducks the speed of a cooling fan embedded within the dictation computer to an optimized speed of rotation over a delay time interval. The fan speed regulator may include components to adapt the optimized speed and delay time to the characteristics of the dictation computer and the user. Other embodiments are also described.

### CROSS-REFERENCE TO RELATED APPLICATIONS

This application claims the benefit of the earlier filing date of provisional application No. 61/657,730, filed Jun. 8, 2012.

### FIELD

An embodiment of the invention generally relates to a dictation computer that adjusts an embedded cooling fan to reduce audio interference to a speech recognition/dictation unit and increase recognition/dictation accuracy. Other embodiments are also described.

### BACKGROUND

Personal computers often include speech recognition and dictation services (hereinafter “speech recognition services”). These services take speech detected by a microphone of the computer and translate the speech into plaintext or other data representing the speech. The plaintext or data may be used to perform an action (e.g. opening a file) or saved for composition of a document or message.

The accuracy of speech recognition services in translating speech into text is largely correlated to the presence or level of ambient noise or sound in areas surrounding the computer. Ambient noise surrounding the computer is picked up by the microphone along with speech from a user. Speech recognition services often have difficulty discerning the ambient noise from user speech as the ambient noise masks or conceals the speech.

The ambient noise may be from sources external to the computer or from components of the computer itself. For example, the computer may include a cooling fan that dissipates heat from integrated processors and memory chips. As the temperature of the computer increases, a fan controller increases the speed of rotation of the fan in an attempt to cool the computer. As the speed of rotation of the fan increases, the noise produced by the fan increases. The noise from the cooling fan may create significant amounts of ambient noise that interferes with the accurate translation of speech to plaintext by the speech recognition services.

### SUMMARY

There is a need for a fan speed regulator that adjusts an embedded cooling fan of a dictation computer to improve speech recognition accuracy while allowing the fan to continue to cool the computer.

An embodiment relates to a dictation computer that includes a fan speed regulator. The fan speed regulator monitors a speech recognition unit to determine when the speech recognition unit is activated. Upon detection that the speech recognition unit is activated, the fan speed regulator ducks the speed of a cooling fan embedded within the dictation computer to an optimized speed of rotation over a delay time interval. The optimized speed of rotation decreases sounds produced by the fan while still allowing the fan to rotate and cool the computer. The fan speed regulator may include components to adapt the optimized speed and delay time to the characteristics of the dictation computer and the user.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows a user speaking into a microphone of a dictation computer that includes an active cooling fan.

FIG. 2 shows a functional unit block diagram and some constituent hardware components of the dictation computer including a fan speed regulator.

FIG. 3 shows a data flow diagram between elements of the fan speed regulator and other elements of the dictation computer.

FIG. 4 shows the gradual transition of the speed of the fan from an original speed to an optimized speed over the entire span of a delay time.

FIG. 5 shows a graph of speech accuracy rates along with corresponding speeds of rotation of the fan.

FIG. 6 shows an example for performing a banking or counting method to determine when the fan has been ducked too much.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

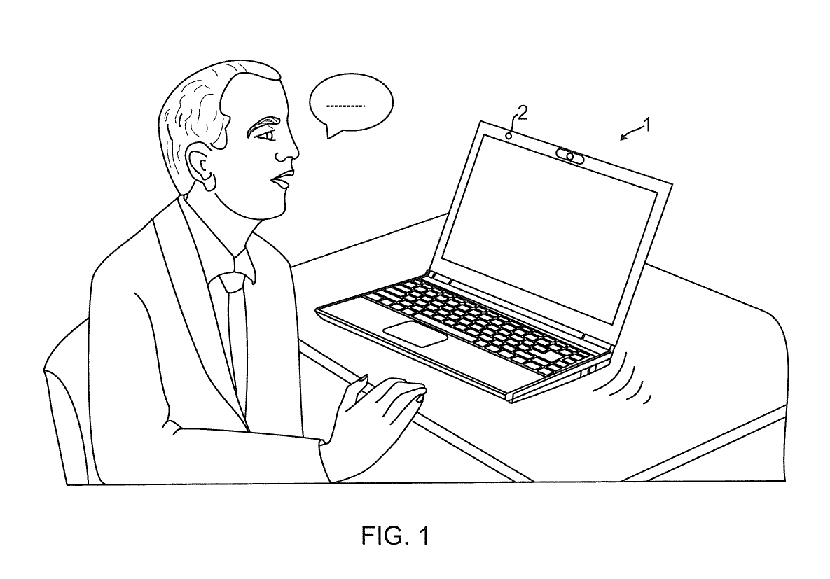

FIG. 1 shows a user speaking into a microphone 2 of a dictation computer 1. Although shown as a laptop computer, the dictation computer 1 may be a desktop, handheld, or mobile computing device. The dictation computer 1 includes an embedded cooling fan that emits whirring or humming sounds that may be picked up by the microphone 2 as the blades of the fan rotate through the air. The sounds emitted by the fan are variable and dependent on the speed of rotation of the fan. For example, as the speed of rotation of the fan increases, the sounds emitted by the fan also increase in volume and frequency. As the volume and/or frequency increases, the fan sounds may interfere with the microphone 2.

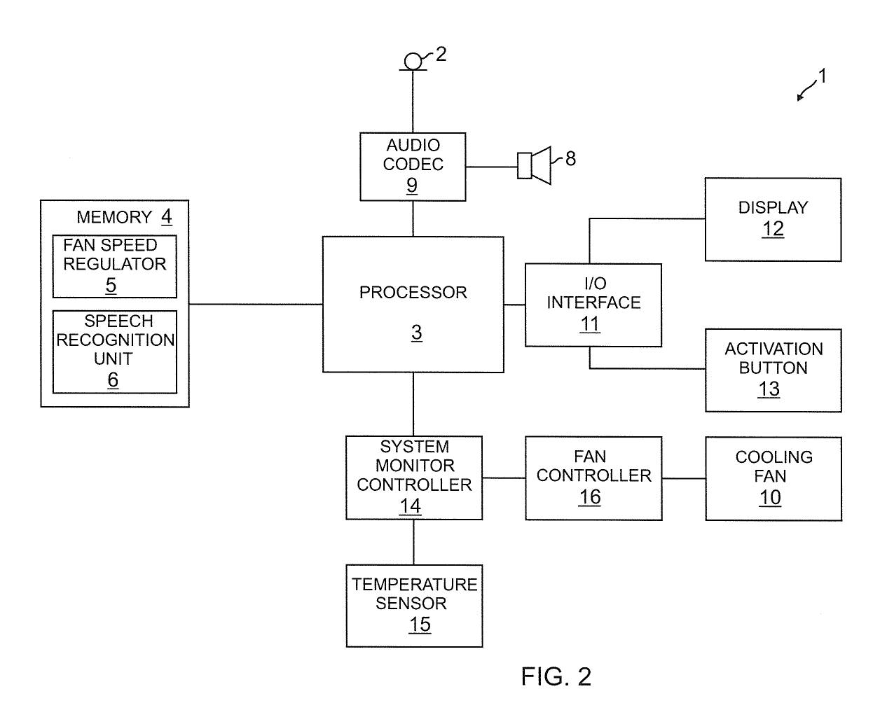

FIG. 2 shows a functional unit block diagram and some constituent hardware components of the dictation computer 1. Each of the elements of the dictation computer 1 will be described by way of example below.

The dictation computer 1 includes one or more processors 3 working in parallel or separately to perform user and system level functions of the computer 1. The processor 3 is programmed in accordance with instructions (code and data) stored in memory 4. The processor 3 and memory 4 are generically used here to refer to any suitable combination of programmable data processing components and data storage that conduct the operations needed to implement the various functions of the dictation computer 1. The processor 3 may be a general purpose processor typically found in a desktop or laptop computer or an application-specific instruction-set processor (ASIP) typically found in a mobile computer, while the memory 4 may refer to microelectronic, non-volatile random access memory. An operating system may be stored in the memory 4, along with application programs specific to the various functions of the dictation computer 1, which are to be run or executed by the processor 3 to perform the various functions of the dictation computer 1. A fan speed regulator 5 and speech recognition unit 6 implemented partially in software may be stored in memory 4 and periodically run by the processor 3.

The dictation computer 1 includes one or more microphones 2 and speakers 8 that are coupled to the processor 3 and the memory 4 through an audio codec chip 9. The microphone 2 and speakers 8 may be integrated into the dictation computer 1 or coupled thereto through a wired or wireless connection.

The microphone 2 is an acoustic-to-electric transducer or sensor that converts sound into an electrical signal. The microphone 2 may use electromagnetic induction (dynamic microphone), capacitance change (condenser microphone), piezoelectric generation, or light modulation to produce an electrical voltage signal from mechanical vibration. In one embodiment, the microphone 2 may be used by the speech recognition unit 6 to perform dictation or voice activation operations. The microphone 2 may also be used by the fan speed regulator 5 to adjust the speed and constituent noise produced by a fan 10 during operation of the speech recognition unit 6. The use of the microphone 2 by the speech recognition unit 6 and the fan speed regulator 5 will be described in further detail below.

The speakers 8 are electroacoustic transducers that produce sound in response to an electrical audio signal. The speakers 8 may include any combination of full-range drivers, mid-range drivers, subwoofers, woofers, and/or tweeters. The speakers 8 may output audio signals produced by applications running on the dictation computer 1. For example, a video conferencing program running on the dictation computer 1 may output audio through the speakers 8.

The audio codec chip 9 performs conversion between the analog domain and digital domain for the microphone 2 and speaker 8 signals. Additionally, the audio codec chip may perform digital audio signal processing for different applications running in the dictation computer 1. The audio codec chip 9 may be configured to operate in different modes. For example, the codec chip 9 may assist in performance of speech recognition operations and assist in performance of non-speech recognition operations (e.g. voice-telephony, video conferencing, recordation of speech notes, or recordation of a movie). In one embodiment, the audio codec chip 9 performs audio equalization on an audio signal prior to being sent to the speech recognition unit 6. The audio codec chip 9 may include an audio equalizer that adjusts the tone or frequency response of an audio signal. This adjustment may be performed by applying different levels of gain to selective areas of the audio signal. For example, the audio equalizer may apply upward or downward equalization to an audio signal. The audio equalization may be performed in the digital domain, using digital filters, or it may be performed in the analog domain using analog filters.

In one embodiment, the dictation computer 1 may include an I/O interface 11 for controlling input and output operations for the dictation computer 1. Input operations may include input received from a physical button or interface element (e.g. a keyboard, a mouse, or a standalone hardware button) or a virtual button or interface element (e.g. a button in an application shown on a display 12). As shown, the dictation computer 1 of FIG. 2 includes an activation button 13 and a display 12; however, more input and output devices may be included in alternate embodiments. In one embodiment, the activation button 13 may be used to activate operation of the speech recognition unit 6 while the display 12 shows a graphic user interface for the speech recognition unit 6.

The dictation computer 1 may include a system monitor controller 14 for managing and controlling low-level operations of the dictation computer 1. In one embodiment, the system monitor controller 14 performs thermal and processor load management of the dictation computer 1. Thermal and processor load management may include the adjustment of the speed of rotation of active heat dissipation elements in the computer 1 (e.g. the fan 10) and processor 3 adjustments (e.g. processor 3 step-down, computer 1 shutdown/sleep, and under-clocking). Although FIG. 2 only shows a single processor 3, the computer 1 may include multiple processors 3 including dedicated graphics processing units that are managed and controlled by the system monitor controller 14. To perform thermal management of the dictation computer 1, the system monitor controller 14 interfaces with a temperature sensor 15, a fan controller 16, and the cooling fan 10.

The temperature sensor 15 measures the temperature of the dictation computer 1. The temperature sensor 15 may be any type of device for measuring temperature within the dictation computer 1. For example, the temperature sensor 15 may be a full system thermometer, bimetallic thermometer, thermocouple, resistance temperature detector, or pyrometer.

The temperature sensor 15 may be coupled to the processor 3 such that the temperature reading from the sensor 15 reflects the temperature of the processor 3. In another embodiment, the temperature sensor 15 is located in a general area of the dictation computer 1 to provide a general temperature of the computer 1. Although shown as a single device, the dictation computer 1 may include multiple temperature sensors 15 located in various locations of the dictation computer 1. The system monitor controller 14 may individually access readings from these multiple sensors 15 to obtain a more complete thermal representation of the dictation computer 1.

The cooling fan 10 is an active cooling device located inside a general housing of the dictation computer 1. The cooling fan 10 may draw cooler air into the dictation computer 1 from the outside, expel warm air from inside, or move air across a heatsink to cool a particular component of the dictation computer 1. The cooling fan 10 includes a set of blades coupled to a variable speed rotary motor. The fan controller 16 adjusts the speed of rotation of the rotary motor and consequently the speed of rotation of the blades. The adjustment by the fan controller 16 may be initiated by an external device or process such as the system monitor controller 14 or the fan speed regulator 5. The fan controller 16 makes adjustments to the speed of rotation of the fan 10 by altering a voltage or current applied to the rotary motor. In one embodiment, the fan controller 16 may throttle or duck (i.e. decrease) the speed of rotation of the fan 10 by applying a reverse voltage to the motor or applying an active break pad to the motor.

As the speed of rotation of the blades of the fan 10 increases heat dissipation also increases. Additionally, as the speed of rotation of the blades increases the noise or sounds emitted by the fan 10 increases. These sounds are typically defined by whirring or humming caused by the blades cutting through air at a high velocity. At high speeds of the fan 10, these sounds may be picked up by the microphone 2 and may interfere with the speech recognition unit 6 or other applications utilizing the microphone 2. While the speech recognition unit 6 is active, the fan speed regulator 5 adjusts the speed of the fan 10 to create a balance between accurate speech recognition and heat dissipation. The process of adjusting the speed or rotation of the fan 10 to balance speech recognition and hear dissipation will be described in further detail below.

Although described herein as being a rotary fan that operates at a variable speed of rotation, the fan 10 may include a non-rotary motor. In these cases it will be understood that the speed of rotation described herein is a general operational speed of the fan.

The speech recognition unit 6 may be activated in response to a trigger from the activation button 13. As described above, the activation button 13 may be a physical hardware button or a virtual button of an application running on the dictation computer 1. In another embodiment, the speech recognition unit 6 is activated in response to a trigger from an application or component without direct interaction from a user. In still another embodiment, the speech recognition unit 6 is activated upon the detection of speech and without interaction from a user or a separate application or component of the computer 1.

Upon activation, the speech recognition unit 6 receives an audio signal from the microphone 2 via the audio codec chip 9. Although shown as residing within the computer 1, the speech recognition unit 6 may be on a remote/external device. For example, the speech recognition unit 6 may be accessible over a network connection in a “cloud” environment. As described above, the audio codec chip 9 may filter or otherwise process the audio signal before reaching the speech recognition unit 6. The speech recognition unit 6 continually processes the audio signal to translate speech represented by the signal into text. The speech recognition unit 6 allows for translation of speech to text using an unrestricted vocabulary (i.e. any word or name in a designated language). Although described herein as translation from speech to text, the speech recognition unit 6 may translate speech into other data types including pointers into nodes of a grammar, a binary representation of text, a bundle of “n-best” hypotheses, or any other representation of results of the recognition process. The translated text may thereafter be passed to another application or file to perform an action, store the data, or generate a request for more information that is necessary before performing an action. In one example, the translated text may be used by an application for performing an action (e.g. opening a file or initiating a phone call). In this example, a phone application on the dictation computer 1 is running and the user selects the activation button 13 to enter in a number or contact to be dialed through voice command. After the user speaks the number or contact into the microphone 2, the speech recognition unit 6 translates the audio into a text phone number (e.g. (408)555-5555). This translated text phone number may thereafter be used by the phone application to place a call or the phone application may request more information from the user (e.g. should the number be stored to a contact).

Although primarily described in relation to dictation, the speech recognition unit 6 may be used to perform any operation that involves the analysis of human voice. For example, the speech recognition unit 6 may perform command and control operations (i.e. to initiate a command through the speech of a user), perform a voice search (i.e. search the Web, an audio broadcast, or a document based on a user's speech inquiry), or perform voice biometrics (i.e. identify a human based on the speech characteristics of a user).

Interference may be caused by the cooling fan 10 as the speech recognition unit 6 may be unable to accurately separate the sounds of the fan 10 from voice or speech of a user. To assist in accurate voice recognition and dictation, the fan speed regulator 5 adjusts the speed of rotation of the fan 10 to increase the accuracy of the speech recognition unit 6 while still maintaining proper heat dissipation in the dictation computer 1 and preventing overheating. Although the interference caused by the fan 10 is primarily described as audio interference, the fan speed regulator 5 may detect and compensate for other forms of interference by the fan 10 to the microphone 2. For example, the fan speed regulator 5 may detect and compensate for RF interference to the microphone 2 caused by the fan 10 emitting a RF signal at a particular speed of rotation, a current offset to the microphone 2 caused by the fan pulling a high current, or any type of interference caused by the fan 10 to the microphone 2.

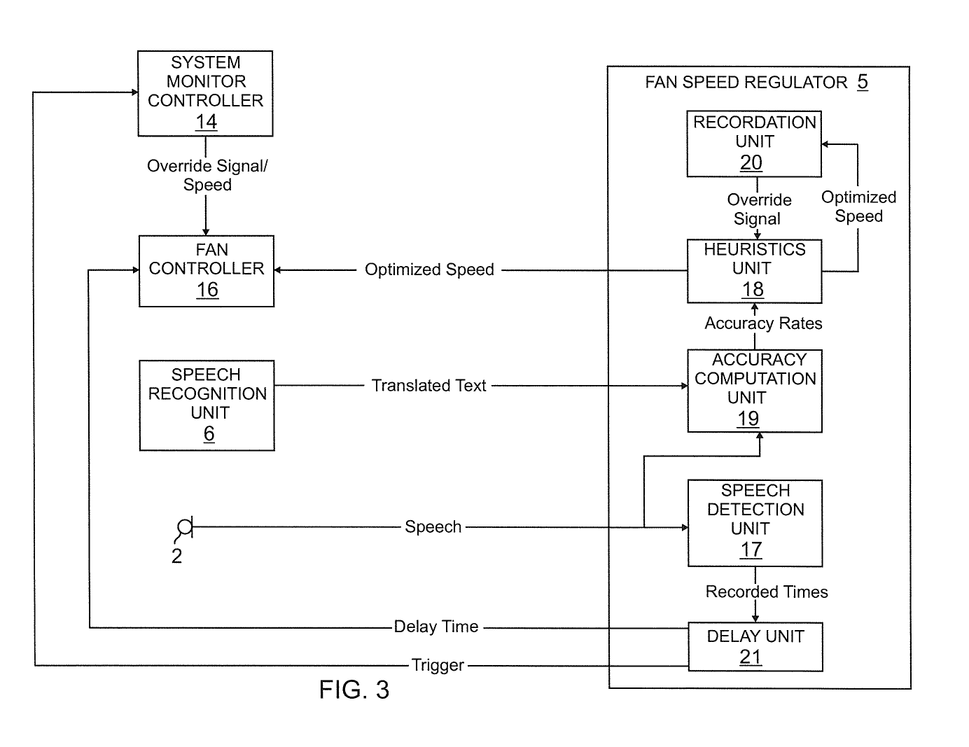

FIG. 3 is a data flow diagram between elements of the fan speed regulator 5 and other elements of the dictation computer 1. Each of these elements will be described by way of example below. It should be understood that each element of the fan speed regulator 5 may be implemented by the processor 3 and discrete hardware structures within the dictation computer 1.

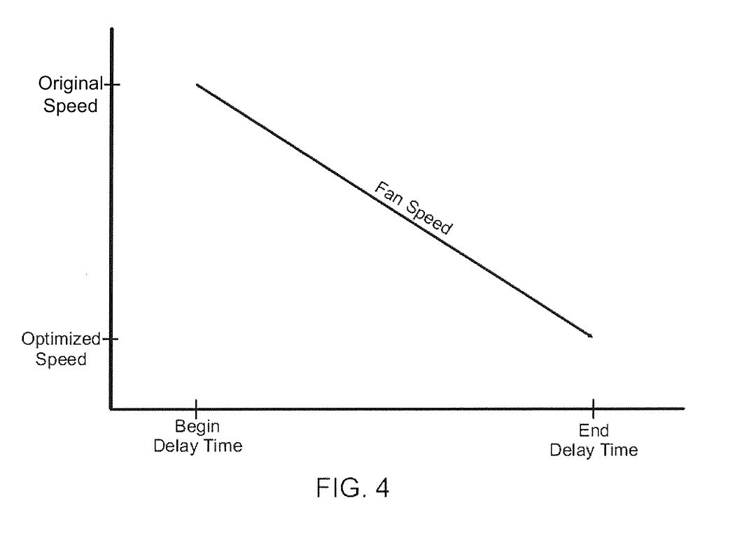

The fan speed regulator 5 adjusts the speed of rotation of the fan 10 after the speech recognition unit 6 has been activated. As discussed above, activation of the speech recognition unit 6 and consequently the fan speed regulator 5 may be in response to interaction from a user, a trigger from an application or component of the computer 1, or upon the detection of speech and without interaction from a user or another element of the computer 1. In one embodiment, the fan speed regulator 5 ducks (i.e. decreases) the speed of rotation of the fan 10 by sending an optimized speed of rotation and a delay time to the fan controller 16. The fan controller 16 gradually changes the speed of rotation of the fan from the current/original speed to the optimized speed over the entire span of the delay time. FIG. 4 shows the gradual transition of the speed of the fan 10 from the original speed to the optimized speed over the entire span of the delay time. The transition from the original speed of rotation to the optimized speed may be linear or non-linear. In one embodiment, the fan speed regulator 5 may also instruct the audio codec chip 9 to mute or reduce in volume audio emitted through the speakers 8 in response to activation of the speech recognition unit 6.

In one embodiment, the optimized speed of rotation and delay time are initially set during manufacture of the dictation computer 1. These predefined values are the result of analytic testing of fan speed, fan noise, and voice recognition accuracy over a diverse set of users, speaking conditions, and fan sizes and types. In one embodiment, the predefined optimized speed of rotation is 2000 rpm and the predefined delay time is 1.5 seconds. In other embodiments, the delay time may be any time less than 4 seconds.

In one embodiment, the fan speed regulator 5 includes a speech detection unit 17. The speech detection unit 17 detects the presence and absence of speech from the audio signal and classifies the absence in speech as either an end or a pause in speech. An end in speech is defined as a point at which the user has completed his thought or request and does not intend to continue speaking. A pause in speech is a point in which the user has briefly stopped speaking, but intends to continue speaking in the immediate future. For example, a pause in speech may be detected by the speech detection unit 17 as an interjection that indicates frustration or indecision (e.g. “Hmmm” or “Ummm”) or an incomplete sentence followed by silence. In contrast, an end of speech may be detected as a complete sentence followed by silence.

Upon the detection of an end of speech, the speech detection unit 17 deactivates the speech recognition unit 6 and instructs the fan controller 16 to increase the speed of rotation of the fan 10 from the optimized speed to the original speed (i.e. speed of rotation prior to activation of speech recognition unit 6). In one embodiment, the speech detection unit 17 triggers the system monitor controller 14 to set the speed of rotation of the fan 10 via the fan controller 16 based on the current heat dissipation needs of the dictation computer 1 instead of automatically reverting the fan 10 to the original speed.

Upon detection of a pause in speech, the speech detection unit 17 triggers the fan controller 16 to briefly raise the speed of rotation of the fan 10 in anticipation of further speech from the user. Upon detecting further speech, the speech detection unit 17 lowers the speed of rotation of the fan 10 to the optimized speed. This brief increase in speed followed by a return to the optimized speed allows the fan 10 to intensify cooling of the dictation computer 1 during a period in which the user is not speaking (i.e. paused). In one embodiment, the increase in speed is greater/faster than the optimized speed but less/slower than the original speed.

In one embodiment, the optimized speed of rotation and delay time are adjustable and adaptable by the fan speed regulator 5 based on the particular usage habits of the user and the individual characteristics of the dictation computer 1 (e.g. fan deterioration or lack of uniformity). The components of the fan speed regulator 5 that adapt the speed of rotation and delay time of the fan 10 are described in further detail below.

The fan speed regulator 5 may include a heuristics unit 18 for setting the optimized speed of rotation of the cooling fan 10 based on the habits and characteristics of the user and the dictation computer 1. In one embodiment the heuristics unit 18 records fan speeds and corresponding speech recognition accuracy rates over time. The speech recognition accuracy rates define the accuracy with which the speech recognition unit 6 is translating speech to text. For example, the speech accuracy rates could indicate that the speech recognition unit 6 accurately translates 95% of speech to text. These speech accuracy rates are recorded along with corresponding speeds of rotation of the fan 10 after each use of the speech recognition unit 6.

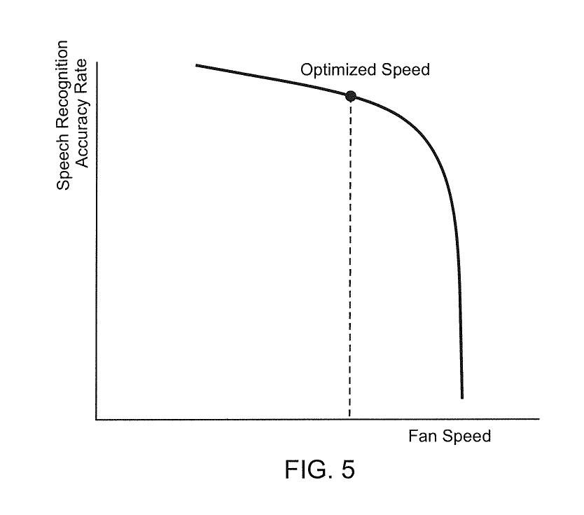

FIG. 5 shows a graph of speech accuracy rates along with corresponding speeds of rotation of the fan 10. As shown, the accuracy rates drop off while the speed of rotation of the fan 10 increases. In one embodiment, the heuristics unit 18 sets the optimized speed of rotation to a speed value just before a large drop in speech accuracy occurs. This allows for high accuracy while still allowing the fan 10 to efficiently cool the dictation computer 1.

The fan speed regulator 5 may include an accuracy computation unit 19 for computing speech recognition accuracy rates of the speech recognition unit 6 over time. In one embodiment, after each use of the speech recognition unit 6 the accuracy computation unit 19 receives the translated text from the speech recognition unit 6 along with the audio signal from the microphone 2 representing the speech from the user. The accuracy computation unit 19 analyzes one or more segments of the translated text along with the audio signal to estimate a speech accuracy rate. For example, the accuracy computation unit 19 may compare three second segments of the audio signal and corresponding segments of the translated text. An overall speech accuracy rate is generated that represents the accuracy computation unit's 19 confidence that the translated text accurately represents the speech of the user based on these analyzed segments.

In other embodiments, the accuracy computation unit 19 calculates speech accuracy rates by analyzing the amount of corrections made by the user to translated text, measuring the signal to noise ratio of the audio signal from the microphone 2, or from a confidence level of the accuracy of the translation retrieved from the speech recognition unit 6. In some embodiments, a combination of these factors may be used by the accuracy computation unit 19 to calculate the speech accuracy rates. As described above, the heuristics unit 18 records these rates along with a corresponding speed of rotation of the fan 10 to determine the optimized speed of rotation.

In one embodiment the system monitor controller 14 may override the speed of rotation of the fan 10 set by the fan speed regulator 5. The system monitor controller 14 continually monitors the temperature of the dictation computer 1 and the processor 3 load to determine a minimum speed the fan 10 must rotate to ensure the processor 3 and other components do not overheat. The system monitor controller 14 compares this minimum speed of rotation with the optimized speed of rotation output by the fan speed regulator 5 and overrides the fan speed regulator 5 when the desired speed of rotation is less than the minimum speed of rotation. When the system monitor controller 14 overrides the fan speed regulator 5, the fan controller 16 is instructed to run the fan at the minimum speed of rotation. The system monitor controller 14 may override the optimized speed of rotation at any time (e.g. when the optimized speed is first received by the fan controller 16 or at any point in the fan 10 ducking/throttling process). Allowing the system monitor controller 14 override the fan speed regulator 5 prevents the dictation system from critically overheating.

In one embodiment, the fan speed regulator may include a recordation unit 20. The recordation unit 20 records the number of seconds the fan 10 has been ducked by the fan speed regulator 5 and the number of seconds the fan 10 has not been ducked. For example, during a five minute period, the speed of rotation of the fan 10 may have been ducked for 200 seconds by the fan regulator unit and consequently remained unmodified for 100 seconds. The recordation unit 20 analyzes these statistics and determines whether the fan 10 has been ducked for too long over the recent period. If the recordation unit determines that the fan 10 has been ducked for too long, the recordation unit 20 may override a current request to duck the speed of rotation of the fan 10 until a more suitable ratio exists. For example, the recordation unit 20 may wait for the ratio of time ducked to time not ducked to be less than or equal to one.

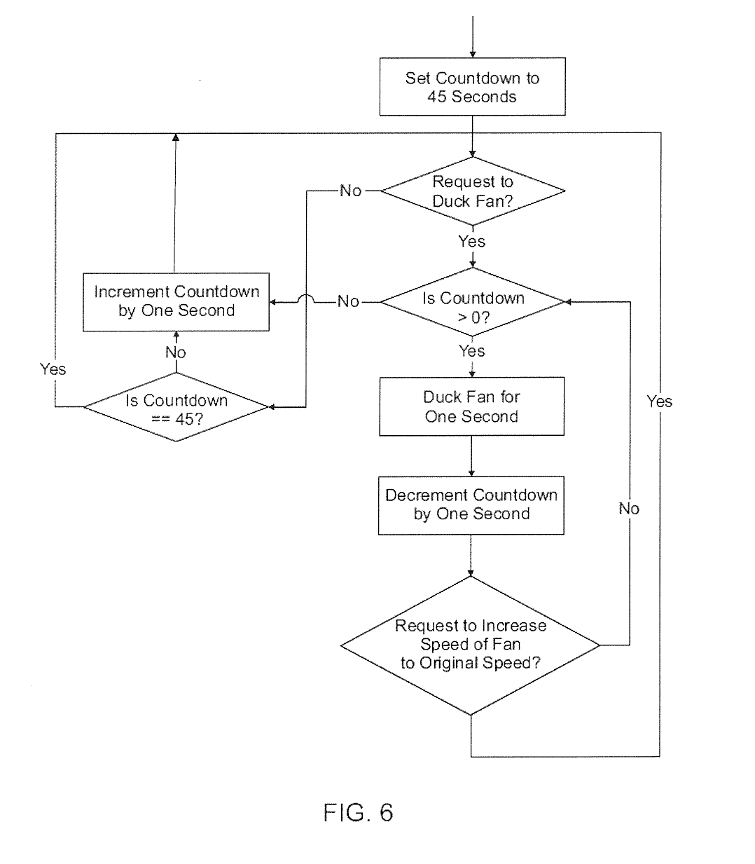

In one embodiment, the recordation unit 20 uses a banking or counting method to determine when the fan 10 has been ducked too much over a discrete time. In this method a countdown is set to a predefined start time (e.g. 45 seconds). For each second the fan 10 is ducked, the countdown is decremented by one second. Similarly, for each second that elapses without ducking the fan 10, the fan 10 is incremented by one second without exceeding the original predefined start time (e.g. 45 seconds). Before ducking the fan 10 can occur, the countdown is checked by the recordation unit 20 to ensure it is greater than zero seconds. If the countdown is greater than zero, the fan speed regulator 5 may duck the speed of rotation of the fan for the remaining time on the countdown. After the countdown has reached zero or the request to duck the fan 10 is completed, the fan 10 is reverted to the original speed of rotation before ducking commenced. FIG. 6 shows an example for performing the banking or counting method described above.

Turning to adjustment of the delay time, the dictation computer 1 may include a delay unit 21 that adjusts the delay time based on previous use of the dictation computer 1 by the user. In one embodiment, the delay time is set based on the average time it takes the user to begin speaking after activating the speech recognition unit 6 through the activation button 13. In this embodiment, the dictation computer 1 uses the speech detection unit 17 to record elapsed times between the activation of the speech recognition unit 6 and detection of speech from the microphone 2 over a period of time. For example, it may take the user 1.3 seconds a first time to begin speaking after activating the speech recognition unit 6, 1.6 seconds a second time, and 1.0 seconds a third time. Each of these elapsed times are recorded by the speech detection unit 17.

The recorded elapsed times are passed to the delay unit 21, which calculates the delay time based on the previously recorded elapsed times. In one embodiment, the delay time is an average of the recorded times. Using an average to compute the delay time with the example elapsed times provided above, the delay time would be set to 1.3 seconds. In other embodiments different sets of calculations may be used to calculate the delay time, including processes for removing outliers. By using the previously recorded times to set the delay time, the delay unit may accurately anticipate when the user typically begins speaking after triggering the activation button 13. This not only allows the fan 10 to rotate at a higher speed for a longer period of time, but allows the fan speed regulator 5 to determine a plan for how the fan 10 will be ducked down to the optimized speed of rotation (e.g. are active braking techniques needed or can the fan be allowed to gradually slow down to the optimized speed of rotation).

In one embodiment, a dictation computer comprises a microphone to receive speech from a user; a speech recognition unit to, upon being activated, translate the speech spoken into the microphone into text; a fan to cool components of the dictation computer; a fan controller for controlling a speed of the fan; a fan speed regulator to instruct the fan controller to duck the speed of the fan from a first speed to a second speed over a delay time in response to activation of the speech recognition unit; and an activation button for activating the speech recognition unit to translate speech to text. In one embodiment, the delay time is less than 1.5 seconds.

In one embodiment, a fan speed regulator, comprises an accuracy computation unit for computing speech recognition accuracy rates of a speech recognition unit over time; and a heuristics unit for (1) recording the recognition accuracy rates and corresponding speeds of a fan and (2) outputting an optimized speed of the fan based on the recorded recognition accuracy rates and the corresponding speeds of rotation. The optimized speed may be less than the current speed of the fan and a fan controller ducks the speed of the fan to the optimized speed of rotation. The fan speed regulator may further comprise a recordation unit to record the number of seconds the fan has been ducked, wherein the recordation unit overrides ducking the fan when the fan has been ducked for a designated number of seconds during a recent time period.

In one embodiment, the fan speed regulator may also comprise (1) a delay unit to set a delay time according to previous use of the speech recognition unit by the user, wherein the fan controller duck the speed of the fan from the original speed to the optimized speed over the span of the delay time and (2) a speech detection unit to detect speech and to record elapsed times between activation of the speech recognition unit and the detection of speech, wherein the delay unit sets the delay time based on an average of the recorded times. In one embodiment, the speech detection unit detects the end of speech and in response (1) deactivates the speech recognition unit and (2) and instructs the fan controller to increase the speed of the fan from the optimized speed to the original speed. In another embodiment, the speech detection unit detects a pause in the speech by the user and instructs the fan controller to increase the speed of the fan to an intermediate speed that is less than the original speed in anticipation of the user's imminent recommencement of speech.

In one embodiment, a method for improving dictation accuracy, comprises detecting a dictation operation in a computer; throttling, in response to detecting the dictation operation, a fan embedded in the computer from a first speed of rotation to a second speed of rotation over the span of a delay time, wherein the second speed of rotation is slower than the first speed of rotation; and setting the delay time according to previous use of the dictation computer by the user. Setting the delay time may include detecting speech from a microphone coupled to the computer; recording elapsed times between the detection of the dictation operation and the detection of speech; and setting the delay time to average of the recorded elapsed times.

In one embodiment, the method for improving dictation accuracy further comprises detecting an end of speech; and increasing, in response to detecting the end of speech, the speed of rotation of the fan from the second speed to the first speed. In another embodiment, the method for improving dictation accuracy further comprises detecting a pause in speech; and increasing, in response to detecting a pause in speech, the speed of rotation of the fan from the second speed to a third speed that is less than the second speed.

To conclude, various aspects of a dictation computer 1 that adjusts an embedded cooling fan 10 to reduce audio interference caused by the fan 10 and increase dictation accuracy has been described. Although described in relation to speech recognition and speech analysis operations, the fan speed regulator 3 may be used to improve the audio fidelity and signal-to-noise ratio of any audio signal from the microphone 2 by reducing the overall interference from the fan 10.

As explained above, an embodiment of the invention may be a machine-readable medium such as one or more solid state memory devices having stored thereon instructions which program one or more data processing components (generically referred to here as “a processor” or a “computer system”) to perform some of the operations described above. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A dictation computer, comprising:
a microphone to receive speech from a user;
a speech recognition unit to, upon being activated, translate the speech spoken into the microphone into text;
a fan to cool components of the dictation computer;
a fan controller for controlling a speed of the fan; and
a fan speed regulator to instruct the fan controller to duck the speed of the fan from a first speed to a second speed over a delay time in response to activation of the speech recognition unit.

2. The dictation computer of claim 1, wherein the fan speed regulator comprises:
an accuracy computation unit for computing speech recognition accuracy rates of the speech recognition unit over time; and
a heuristics unit for recording the recognition accuracy rates and corresponding speeds of the fan, wherein in a graph of the recorded speech recognition accuracy rates and the corresponding speeds the second speed is set by the heuristics unit to an optimized value just before the speech recognition accuracy rates undergo a rapid decrease.

3. The dictation computer of claim 2, further comprising:
a system monitor controller to monitor the temperature of the dictation computer, predict future increases in the temperature of the dictation computer and calculate a lowest possible speed of the fan that prevents the dictation computer from overheating,
wherein the system monitor overrides the heuristics unit and sets the second speed to the calculated lowest possible speed when the lowest possible speed is greater than the optimized value.

4. The dictation computer of claim 1, wherein the fan speed regulator comprises:
a recordation unit to record the number of seconds the fan has been ducked, wherein the recordation unit overrides ducking the fan when the fan has been ducked for a designated number of seconds during a recent time period.

5. The dictation computer of claim 1, wherein the fan speed regulator comprises:
a delay unit to set the delay time according to previous use of the dictation computer by the user.

6. The dictation computer of claim 5, wherein the fan speed regulator further comprises:
a speech detection unit to detect speech and record elapsed times between the activation of the speech recognition unit and the detection of speech, wherein the delay unit sets the delay time to the average of the recorded elapsed times.

7. The dictation device of claim 6, wherein the speech detection unit detects the end of speech and in response (1) deactivates the speech recognition unit and (2) and instructs the fan controller to increase the speed of the fan from the second speed to the first speed.

8. The dictation computer of claim 6, wherein the speech detection unit detects a pause in the speech by the user and instructs the fan controller to increase the speed of the fan to a third speed that is less than the second speed in anticipation of the user's imminent recommencement of speech.

9. The dictation computer of claim 1, wherein the speech recognition unit uses an unrestricted vocabulary.

10. The dictation computer of claim 2, wherein the accuracy computation unit calculates the speech recognition accuracy rates based on an amount of corrections made by the user to the translated text, a signal to noise ratio of an audio signal representing the speech from the microphone, or a confidence level representing an accuracy of the translated text.

11. A method for improving dictation accuracy, comprising:
detecting a dictation operation in a computer; and
throttling, in response to detecting the dictation operation, a fan embedded in the computer from a first speed of rotation to a second speed of rotation over the span of a delay time, wherein the second speed of rotation is slower than the first speed of rotation.

12. The method of claim 11, further comprising:
calculating the second speed of rotation by:
recording accuracy rates of the dictation operation over time and corresponding speeds of rotation of the fan; and
setting the second speed of rotation to an optimized value just before the recorded accuracy rates undergo a rapid decrease in relation to the recorded speeds of rotation of the fan.

13. The method of claim 12, further comprising:
monitoring the temperature of the computer;
predicting future increases in the temperature of the computer;
calculating, based on the predicted future temperature increases, a lowest possible speed of rotation of the fan that prevents the computer from overheating;
overriding the throttling to the second speed of rotation when the lowest possible speed of rotation is greater than the optimized value; and
throttling the fan to the calculated lowest possible speed of rotation.

14. The method of claim 11, further comprising:
recording the number of seconds the fan has been throttled to the second speed of rotation, wherein the recordation unit overrides throttling the fan to the second speed of rotation when the fan has been throttled for a designated number of seconds during a recent time period.

15. The method of claim 11, wherein setting the delay time comprises:
detecting speech from a microphone coupled to the computer;
recording elapsed times between the detection of the dictation operation and the detection of speech; and
setting the delay time to average of the recorded elapsed times

16. An article of manufacture, comprising:
a machine-readable storage medium that stores instructions which, when executed by a processor in a computer,
detect a dictation operation in the computer, and
throttle, in response to detecting the dictation operation, a fan embedded in the computer, from a first speed to a second speed over the span of a delay time, wherein the second speed is slower than the first speed.

17. The article of manufacture of claim 16, wherein the storage medium includes further instructions to calculate the second speed, by
recording accuracy rates of the dictation operation over time and corresponding speeds of the fan, and
setting the second speed to an optimized value just before the recorded accuracy rates undergo a rapid decrease in relation to the recorded speeds of the fan.

18. The article of manufacture of claim 17, wherein the storage medium includes further instructions which, when executed by the processor,
monitor the temperature of the computer,
predict future increases in the temperature of the computer,
calculate, based on the predicted future temperature increases, a lowest possible speed of the fan that prevents the computer from overheating,
override the throttling to the second speed when the lowest possible speed is greater than the optimized value, and
throttle the fan to the calculated lowest possible speed.

19. The article of manufacture of claim 16, wherein the storage medium includes further instructions which, when executed by the processor,
record the number of seconds the fan has been throttled to the second speed, wherein the recordation unit overrides throttling the fan to the second speed when the fan has been throttled for a designated number of seconds during a recent time period.

20. The article of manufacture of claim 16, wherein the storage medium includes further instructions which, when executed by the processor,
set the delay time according to previous use of the dictation computer by the user.

21. The article of manufacture of claim 20, wherein the storage medium includes further instructions to set the delay time which, when executed by the processor,
detect speech from a microphone coupled to the computer,
record elapsed times between the detection of the dictation operation and the detection of speech, and
set the delay time to average of the recorded elapsed times.

22. The article of manufacture of claim 21, wherein the storage medium includes further instructions which, when executed by the processor,
detect an end of speech, and
increase, in response to detecting the end of speech, the speed of the fan from the second speed to the first speed.

23. The article of manufacture of claim 21, wherein the storage medium includes further instructions which, when executed by the processor,
detect a pause in speech, and
increase, in response to detecting a pause in speech, the speed of the fan from the second speed to a third speed that is less than the second speed.
